(19) United States
(12) Patent Application Publication
(10) Pub. No.: US 2024/0009790 A1
(43) Pub. Date: Jan. 11, 2024

(54) METHOD OF MONITORING MACHINE TOOL AND METHOD OF DETERMINING A STANDARD FOR EVALUATING ABNORMALITY OF A MACHINE TOOL

(71) Applicant: NATIONAL FORMOSA UNIVERSITY, Yun-Lin County (TW)

(72) Inventors: TZU-CHI CHAN, YUN-LIN COUNTY (TW); JYUN-DE LI, YUN-LIN COUNTY (TW); YI-FAN SU, YUN-LIN COUNTY (TW); XIAN-YOU SHAO, YUN-LIN COUNTY (TW); YI-HAO CHEN, YUN-LIN COUNTY (TW); SHINN-LIANG CHANG, YUN-LIN COUNTY (TW); I-HUNG WANG, YUN-LIN COUNTY (TW); SHAO-CHI WU, YUN-LIN COUNTY (TW)

(21) Appl. No.: 18/083,320

(22) Filed: Dec. 16, 2022

(30) Foreign Application Priority Data
Jul. 11, 2022 (TW) 111125972

(51) Int. Cl. B23Q 17/09; B23Q 17/10

(52) U.S. Cl. CPC B23Q 17/0995; B23Q 17/10

(57) ABSTRACT

A method includes steps of: performing preparation-phase measurements on a spindle of a machine tool to generate normal-condition signals; establishing a reference model based on the normal-condition signals; generating abnormal-condition signals based on the reference model and a preset damage value; utilizing principal components analysis (PCA) to characterize the normal-condition and abnormal-condition signals to obtain normal and abnormal probabilistic models, determining normal-condition and abnormal-condition reference curves based on the normal and abnormal probabilistic models; determining an alert-triggering line based on the abnormal-condition reference curve; determining a permissible range between the alert-triggering line and the normal-condition reference curve; and generating a warning signal when it is determined that a detection value falls outside of the permissible range, wherein the detection value is obtained based on application-phase measurements performed on the spindle.

### CROSS-REFERENCE TO RELATED APPLICATION

This application claims priority to Taiwanese Invention Patent Application No. 111125972, filed on Jul. 11, 2022.

### FIELD

The disclosure relates to a method of monitoring a machine tool and a method of determining a standard for evaluating abnormality of a machine tool.

### BACKGROUND

A spindle is an essential component of a machine tool, and a health condition of the spindle deeply affects efficiency of the machining process and accuracy of products produced through machining using the machine tool. The spindle may be frequently abraded by other components of the machine tool, and thus is prone to abnormalities that would adversely impact operations of the machine tool, such as dynamic unbalance, overly-high oscillation frequency and abnormal temperature.

Conventionally, a technician inspects the health condition of the spindle based on sounds made by the spindle when the machine tool is operating. However, a result of the inspection relies on experience and expertise of the technician, and mainly involves subjective decision of the technician rather than objective determination made based on a quantitative standard. Moreover, relevant technicians are not informed in time when the spindle encounters an abnormality.

### SUMMARY

Therefore, an object of the disclosure is to provide a method of determining a standard for evaluating abnormality of a machine tool and a method of monitoring a machine tool that can alleviate at least one of the drawbacks of the prior art.

According to one aspect of the disclosure, the machine tool includes a spindle. The method is to be implemented by a monitoring system. The monitoring system includes a sensor and a processing device that are electrically connected to each other. The method includes steps of:
the sensor performing a preparation-phase measurement on the spindle multiple times to respectively generate a plurality of normal-condition signals under a condition where the spindle of the machine tool is idling at a preset speed in a normal condition, and transmitting the normal-condition signals to the processing device;
the processing device establishing a reference model based on the normal-condition signals, and generating a plurality of abnormal-condition signals based on the reference model and a preset damage value;
the processing device utilizing principal components analysis (PCA) to characterize the normal-condition signals to obtain a normal probabilistic model and characterize the abnormal-condition signals to obtain an abnormal probabilistic model, and determining a normal-condition reference curve and an abnormal-condition reference curve respectively based on the normal probabilistic model and the abnormal probabilistic model; and

the processing device determining an alert-triggering line based on the abnormal-condition reference curve, and determining a permissible range between the alert-triggering line and the normal-condition reference curve, wherein the permissible range serves as the standard for evaluating abnormality of the machine tool.

According to another aspect of the disclosure, the machine tool includes a spindle. The method is to be implemented by a monitoring system. The monitoring system includes a processing device, a sensor electrically connected to the processing device, a storage medium electrically connected to the processing device, and an output device electrically connected to the processing device. The storage medium stores a normal-condition reference curve and a permissible range. The method includes steps of:
the sensor performing an application-phase measurement on the spindle multiple times to respectively generate a plurality of detection signals under a condition where the spindle of the machine tool is rotating at a preset speed, and transmitting the detection signals to the processing device;
the processing device utilizing principal components analysis (PCA) to characterize the detection signals to obtain a detection probabilistic model, and determining a detection value based on the detection probabilistic model; and
the processing device determining a distance between the detection value and the normal-condition reference curve, determining, based on the distance between the detection value and the normal-condition reference curve, whether the detection value falls outside of the permissible range, generating a warning signal when it is determined that the detection value falls outside of the permissible range, and transmitting the warning signal to the output device (25) for outputting an alert.

### BRIEF DESCRIPTION OF THE DRAWINGS

Other features and advantages of the disclosure will become apparent in the following detailed description of the embodiment(s) with reference to the accompanying drawings. It is noted that various features may not be drawn to scale.

FIG. 1 is a block diagram illustrating an example of a monitoring system for monitoring a machine tool according to an embodiment of the disclosure.

FIG. 2 is a plot exemplarily showing a normal probabilistic model and an abnormal probabilistic model obtained by a method of monitoring a machine tool according to an embodiment of the disclosure.

FIG. 3 is a plot exemplarily showing a normal-condition reference curve, an abnormal-condition reference curve and an alert-triggering line obtained by the method of monitoring a machine tool according to an embodiment of the disclosure.

FIGS. 4 and 5 are flow charts cooperatively illustrating an example of the method of monitoring a machine tool according to an embodiment of the disclosure.

### DETAILED DESCRIPTION

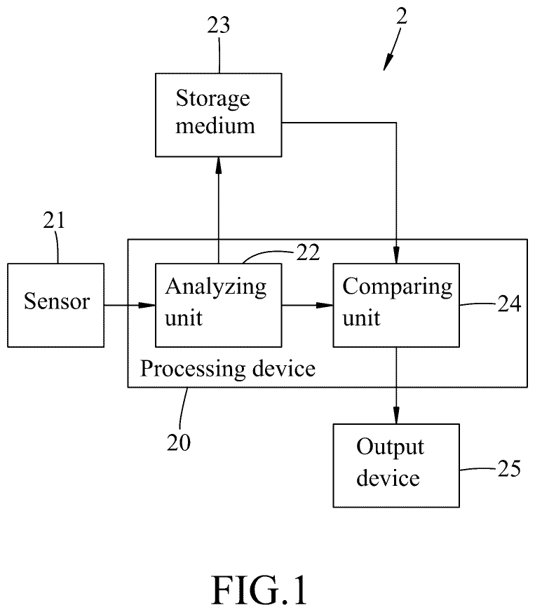

Referring to FIG. 1, an embodiment of a monitoring system 2 for monitoring a machine tool according to the disclosure is illustrated. The monitoring system 2 is adapted to implement a method of determining a standard for evaluating abnormality of a machine tool and a method of monitoring the machine tool. For example, the machine tool is a computer numerical control (CNC) machine tool, and includes a spindle (not shown).

The monitoring system 2 includes a processing device 20, a sensor 21, a storage medium 23 and an output device 25. The processing device 20 includes an analyzing unit 22 and a comparing unit 24. The analyzing unit 22 is electrically connected to the sensor 21 and the storage medium. The comparing unit 24 is electrically connected to the analyzing unit 22, the storage medium 23 and the output device 25.

The processing device 20 may be implemented by a processor, a central processing unit (CPU), a microprocessor, a micro control unit (MCU), a system on a chip (SoC), or any circuit configurable/programmable in a software manner and/or hardware manner to implement functionalities discussed in this disclosure.

The sensor 21 is implemented by one of an accelerator, a thermometer and a current detector (for measuring electric current), but is not limited thereto.

The storage medium 23 may be implemented by random access memory (RAM), double data rate synchronous dynamic random access memory (DDR SDRAM), read only memory (ROM), programmable ROM (PROM), flash memory, a hard disk drive (HDD), a solid state disk (SSD), electrically-erasable programmable read-only memory (EEPROM) or any other volatile/non-volatile memory devices, but is not limited thereto.

The output device 25 may be implemented by a display and/or a speaker. In some embodiments, the output device 25 may be implemented by an electronic device (e.g., a smartphone) running a chatbot (e.g., a “LINE Bot”) that is integrated in an instant messaging (IM) software program (e.g., “Line” application software) and that is capable of outputting an alert (e.g., a text message indicating that the machine tool is under an abnormal condition).

Each of the analyzing unit 22 and the comparing unit 24 may be implemented by one of hardware, firmware, software, and any combination thereof. For example, the analyzing unit 22 and the comparing unit 24 may be implemented to be software modules in an analysis program executed by the processing device where the software modules contain codes and instructions to carry out specific functionalities that will be described in the following. The above-mentioned modules may be embodied in: executable software as a set of logic instructions stored in a machine- or computer-readable storage medium of a memory such as RAM, ROM, PROM, firmware, flash memory, etc.; configurable logic such as programmable logic arrays (PLAs), field programmable gate arrays (FPGAs), complex programmable logic devices (CPLDs), etc.; fixed-functionality logic hardware using circuit technology such as application specific integrated circuit (ASIC), complementary metal oxide semiconductor (CMOS), transistor-transistor logic (TTL) technology, etc.; or any combination thereof.

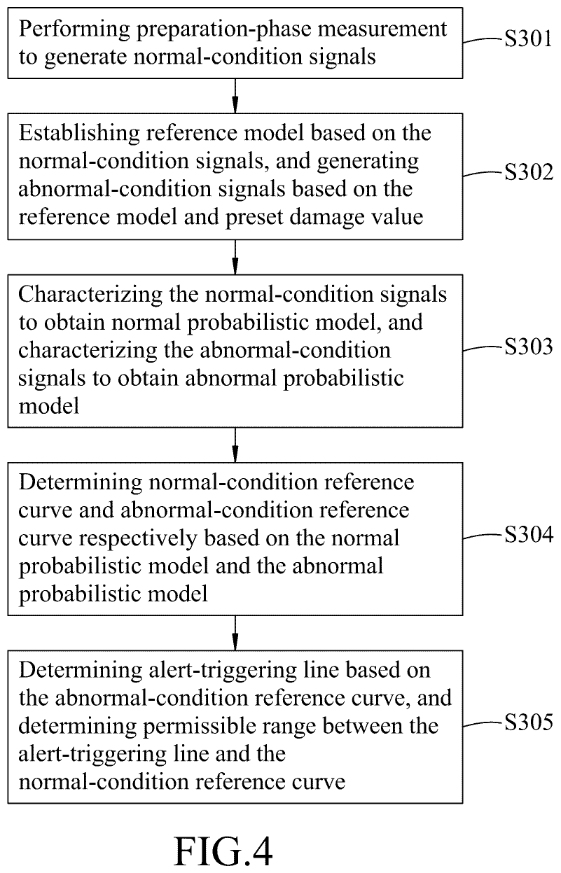

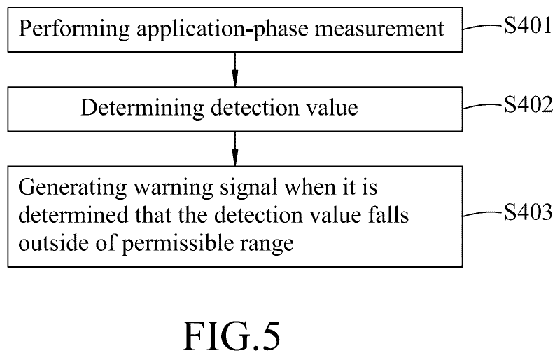

Referring to FIGS. 4 and 5, an embodiment of a method of monitoring a machine tool according to the disclosure is illustrated. The method is adapted to be implemented by the monitoring system 2 that is previously described. The method includes a preparation phase and an application phase.

As shown in FIG. 4, the preparation phase includes steps S301 to S305 delineated below.

In step S301, the sensor 21 performs a preparation-phase measurement on the spindle multiple times to respectively generate a plurality of normal-condition signals under a condition where the spindle is idling at a preset speed (e.g., 6000 rpm) in a normal condition. Then, the sensor 21 transmits the normal-condition signals to the analyzing unit 22.

In one embodiment where the sensor 21 is an accelerator, the sensor 21 measures vibration of the spindle (e.g., by measuring frequency and/or amplitude of the vibration), and each of the normal-condition signals indicates a waveform of the vibration of the spindle in a period of a preset time length (e.g., one second).

In one embodiment where the sensor 21 is a thermometer, the sensor 21 measures temperature of the spindle, and each of the normal-condition signals indicates values of the temperature of the spindle detected by the thermometer in a period of the preset time length.

In one embodiment where the sensor 21 is a current detector, the sensor 21 measures electric current for driving the spindle, and each of the normal-condition signals indicates values of the electric current driving the spindle detected by the current detector in a period of the preset time length.

In step S302, the analyzing unit 22 establishes a reference model based on the normal-condition signals, and generates a plurality of abnormal-condition signals based on the reference model and a preset damage value. Specifically, the analyzing unit 22 performs linear discriminant analysis (LDA) on the normal-condition signals to obtain the reference model.

It should be noted that the content of each of the abnormal-condition signals is similar to that of each of the normal-condition signals. That is to say, in one embodiment where the sensor 21 is an accelerator, each of the abnormal-condition signals indicates a waveform of the vibration of the spindle in a period of the preset time length if the spindle is idling at the preset speed in an abnormal condition. In one embodiment where the sensor 21 is a thermometer, each of the abnormal-condition signals indicates the temperature of the spindle in a period of the preset time length if the spindle is idling at the preset speed in the abnormal condition. In one embodiment where the sensor 21 is a current detector, each of the abnormal-condition signals indicates the electric current driving the spindle in a period of the preset time length if the spindle is idling at the preset speed in the abnormal condition.

It is worth to note that the preset damage value is determined as a quotient of a root mean square of normal values (e.g., normal vibration frequencies) that are derived from the normal-condition signals divided by an abnormal value (e.g., an abnormal vibration frequency) that is determined based on a range of the normal values.

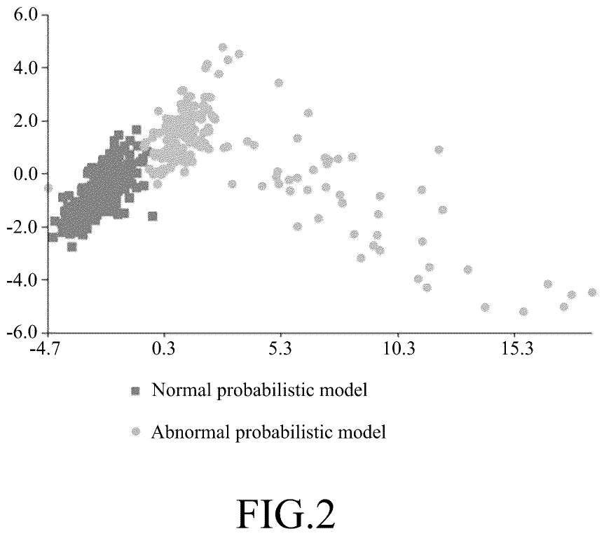

In step S303, the analyzing unit 22 utilizes principal components analysis (PCA) to characterize the normal-condition signals to obtain a normal probabilistic model and characterize the abnormal-condition signals to obtain an abnormal probabilistic model. Each of the normal probabilistic model and the abnormal probabilistic model is a Gaussian mixture model (GMM). FIG. 2 illustrates projections respectively of the normal probabilistic model and the abnormal probabilistic model on a plane defined by two dimensions that are selected from among multiple dimensions of the normal-condition signals and the abnormal-condition signals, and each dot in FIG. 2 represents a projection of a characteristic point of the normal probabilistic model (or the abnormal probabilistic model). The normal probabilistic model is a representation of the normal-condition signals that are related to the normal condition of the spindle of the machine tool, and the abnormal probabilistic model is a representation of the abnormal-condition signals that are related to the abnormal condition of the spindle of the machine tool. It is worth to note that in a scenario where each of the normal-condition signals and the abnormal-condition signals indicates a waveform of the vibration of the spindle in a period of the preset time length, the analyzing unit 22 characterizes each of the normal-condition signals and the abnormal-condition signals to obtain specific characteristics such as a time-domain characteristic (e.g., an inter-spike interval) of the vibration of the spindle, a frequency-domain characteristic (e.g., a bandwidth) of the vibration of the spindle, and an envelope of the waveform of the vibration of the spindle.

Specifically, in utilizing PCA to characterize the normal-condition signals, for each of the normal-condition signals, the analyzing unit 22 performs linear combination on the specific characteristics (e.g., the time-domain characteristic of the vibration of the spindle, the frequency-domain characteristic of the vibration of the spindle, and the envelope of the waveform of the vibration of the spindle) of the normal-condition signal to achieve dimensionality reduction so as to obtain principal components defining a Gaussian model (GM) of the normal-condition signal such that the principal components thus obtained explain the most variance. Next, the analyzing unit 22 performs k-means clustering on the GMs respectively of the normal-condition signals to obtain initialization parameters for initializing the normal probabilistic model, which is a GMM. Subsequently, the analyzing unit 22 performs expectation-maximization (EM) algorithm on the initialization parameters to obtain an equation of the initialization parameters, performs iterative method on the equation of the initialization parameters to update parameters of the normal probabilistic model, and performs maximum likelihood estimation (MLE) to optimize the normal probabilistic model.

Similarly, for each of the abnormal-condition signals, the analyzing unit 22 performs linear combination on the specific characteristics of the abnormal-condition signal to achieve dimensionality reduction so as to obtain principal components defining a GM of the abnormal-condition signal such that the principal components thus obtained explain the most variance. Next, the analyzing unit 22 performs k-means clustering on the GMs respectively of the abnormal-condition signals to obtain initialization parameters for initializing the abnormal probabilistic model, which is a GMM. Subsequently, the analyzing unit 22 performs EM algorithm on the initialization parameters to obtain an equation of the initialization parameters, performs iterative method on the equation of the initialization parameters for updating parameters of the abnormal probabilistic model, and performs MLE to optimize the abnormal probabilistic model.

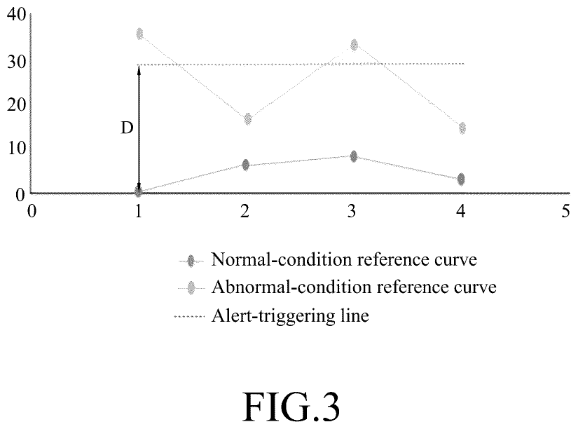

Referring to FIG. 3, in step S304, the analyzing unit 22 determines a normal-condition reference curve and an abnormal-condition reference curve respectively based on the normal probabilistic model and the abnormal probabilistic model, and transmits the normal-condition reference curve, the abnormal-condition reference curve, the normal probabilistic model and the abnormal probabilistic model to the storage medium 23 for storage. Specifically, the analyzing unit 22 obtains projections respectively of the characteristic points of the normal probabilistic model (see FIG. 2) by using data projection technique and LDA, and quantifies a distribution of the projections respectively of the characteristic points of the normal probabilistic model to obtain the normal-condition reference curve. Similarly, the analyzing unit 22 obtains projections respectively of the characteristic points of the abnormal probabilistic model (see FIG. 2) by using data projection technique and LDA, and quantifies a distribution of the projections respectively of the characteristic points of the abnormal probabilistic model to obtain the abnormal-condition reference curve.

In step S305, the comparing unit 24 obtains the abnormal-condition reference curve from the storage medium 23. Next, the comparing unit 24 determines an alert-triggering line based on the abnormal-condition reference curve, and determines a permissible range (D) between the alert-triggering line and the normal-condition reference curve (see FIG. 3). Then, the comparing unit transmits the permissible range to the storage medium (23) for storage. In one embodiment, the comparing unit 24 determines the alert-triggering line by performing regression analysis (e.g., linear regression, polynomial regression, stepwise regression or the like) on the abnormal-condition reference curve. In one embodiment, the comparing unit 24 uses a maximum of the abnormal-condition reference curve to define the alert-triggering line (for example, the alert-triggering line is a constant function with the constant being the maximum of the abnormal-condition reference curve). In one embodiment, the alert-triggering line is defined by a preset constant value that is determined based on practical needs and that is not smaller than a closest distance between the normal-condition reference curve and the abnormal-condition reference curve.

It is worth to note that in one embodiment, multiple reference-curve sets, with each set having a normal-condition reference curve and an abnormal-condition reference curve, are obtained respectively for a plurality of conditions where the spindle is rotating respectively at various preset speeds (e.g., 6000 rpm, 7000 rpm and 10000 rpm). The reference-curve sets thus obtained are transmitted to the storage medium 23 for storage therein as a database, and the database can be utilized to establish a quantitative standard to facilitate monitoring of a health condition of a machine tool (evaluating abnormality of the machine tool) under different rotational speeds of the spindle of the machine tool.

At the end of the preparation phase, a procedure flow of the method proceeds to the application phase for determining the health condition of the spindle of the machine tool. Referring to FIG. 5, the application phase includes steps S401 to S403 delineated below.

In step S401, the sensor 21 performs an application-phase measurement on the spindle multiple times to respectively generate a plurality of detection signals under a condition where the spindle of the machine tool is rotating at the preset speed (i.e., 6000 rpm). Then, the sensor 21 transmits the detection signals to the analyzing unit 22.

In step S402, the analyzing unit 22 utilizes PCA to characterize the detection signals to obtain a detection probabilistic model, and determines a detection value based on the detection probabilistic model. Then, the analyzing unit 22 transmits the detection probabilistic model and the detection value to the comparing unit 24. It should be noted that the content of each of the detection signals is similar to that of each of the normal-condition signals. In other words, each of the detection signals indicates a waveform of the vibration of the spindle in a period of the preset time length when the sensor 21 is an accelerator, indicates the temperature of the spindle in a period of the preset time length when the sensor 21 is a thermometer, and indicates the electric current driving the spindle in a period of the preset time length when the sensor 21 is a current detector.

In step S403, the comparing unit 24 determines a distance between the detection value and the normal-condition reference curve, and determines, based on the distance between the detection value and the normal-condition reference curve, whether the detection value falls outside of the permissible range (D). The comparing unit 24 generates a warning signal when it is determined that the detection value falls outside of the permissible range (D), and transmits the warning signal to the output device 25 for outputting an alert (e.g., broadcasting a warning text message via a “LINE Bot” integrated in “Line” application software in a smartphone carried by each relevant technician). In this way, a relevant technician may be notified in time when an abnormality occurs in the spindle of the machine tool, and may thus be able to deal with the abnormality, accordingly.

In one embodiment, the comparing unit 24 determines the health condition of the spindle of the machine tool by comparing a distribution of characteristic points of the detection probabilistic model with the distribution of the characteristic points of the normal probabilistic model and the distribution of the characteristic points of the abnormal probabilistic model, see FIG. 2, for example.

To sum up, in the method according to the disclosure, the monitoring system generates the normal-condition signals and the abnormal-condition signals that are related to the preparation-phase measurements performed on the spindle of the machine tool, characterizes the normal-condition signals and the abnormal-condition signals by using PCA to obtain the normal probabilistic model and the abnormal probabilistic model, and obtains the normal-condition reference curve and the abnormal-condition reference curve respectively based on the normal probabilistic model and the abnormal probabilistic model. Thereafter, the monitoring system determines the alert-triggering line based on the abnormal-condition reference curve, and determines the permissible range (D) between the alert-triggering line and the normal-condition reference curve. In this way, an objective standard for evaluating abnormality of the machine tool is established. Furthermore, the monitoring system determines the detection value that is related to the application-phase measurements, and generates the warning signal for outputting an alert when it is determined that the detection value falls outside of the permissible range (D). As a result, a relevant technician may be notified in time whenever the machine tool is under an abnormal condition.

In the description above, for the purposes of explanation, numerous specific details have been set forth in order to provide a thorough understanding of the embodiment(s). It will be apparent, however, to one skilled in the art, that one or more other embodiments may be practiced without some of these specific details. It should also be appreciated that reference throughout this specification to “one embodiment,” “an embodiment,” an embodiment with an indication of an ordinal number and so forth means that a particular feature, structure, or characteristic may be included in the practice of the disclosure. It should be further appreciated that in the description, various features are sometimes grouped together in a single embodiment, figure, or description thereof for the purpose of streamlining the disclosure and aiding in the understanding of various inventive aspects; such does not mean that every one of these features needs to be practiced with the presence of all the other features. In other words, in any described embodiment, when implementation of one or more features or specific details does not affect implementation of another one or more features or specific details, said one or more features may be singled out and practiced alone without said another one or more features or specific details. It should be further noted that one or more features or specific details from one embodiment may be practiced together with one or more features or specific details from another embodiment, where appropriate, in the practice of the disclosure.

While the disclosure has been described in connection with what is(are) considered the exemplary embodiment(s), it is understood that this disclosure is not limited to the disclosed embodiment(s) but is intended to cover various arrangements included within the spirit and scope of the broadest interpretation so as to encompass all such modifications and equivalent arrangements.

What is claimed is:

1. A method of determining a standard for evaluating abnormality of a machine tool that includes a spindle, the method to be implemented by a monitoring system including a sensor and a processing device that are electrically connected to each other, the method comprising steps of:
the sensor performing a preparation-phase measurement on the spindle multiple times to respectively generate a plurality of normal-condition signals under a condition where the spindle of the machine tool is idling at a preset speed in a normal condition, and transmitting the normal-condition signals to the processing device;
the processing device establishing a reference model based on the normal-condition signals, and generating a plurality of abnormal-condition signals based on the reference model and a preset damage value;
the processing device utilizing principal components analysis (PCA) to characterize the normal-condition signals to obtain a normal probabilistic model and characterize the abnormal-condition signals to obtain an abnormal probabilistic model, and determining a normal-condition reference curve and an abnormal-condition reference curve respectively based on the normal probabilistic model and the abnormal probabilistic model; and
the processing device determining an alert-triggering line based on the abnormal-condition reference curve, and determining a permissible range between the alert-triggering line and the normal-condition reference curve, wherein the permissible range serves as the standard for evaluating abnormality of the machine tool.

2. The method as claimed in claim 1, wherein each of the normal probabilistic model and the abnormal probabilistic model is a Gaussian mixture model (GMM).

3. The method as claimed in claim 1, wherein the step of determining an alert-triggering line is to determine the alert-triggering line by performing regression analysis on the abnormal-condition reference curve.

4. The method as claimed in claim 1, wherein the step of determining an alert-triggering line is to select a maximum of the abnormal-condition reference curve to define the alert-triggering line.

5. The method as claimed in claim 1, wherein:
in the step of performing a preparation-phase measurement on the spindle multiple times, the preparation-phase measurement is to measure one of vibration of the spindle, temperature of the spindle, and electric current driving the spindle, and each of the normal-condition signals indicates a waveform, in a period of a preset time length, of said one of the vibration of the spindle, the temperature of the spindle, and the electric current driving the spindle.

6. The method as claimed in claim 1, wherein the sensor is one of an accelerator, a thermometer and a current detector.

7. A method of monitoring a machine tool that includes a spindle, the method to be implemented by a monitoring system including a processing device, a sensor electrically connected to the processing device, a storage medium electrically connected to the processing device, and an output device electrically connected to the processing device, the storage medium storing a normal-condition reference curve and a permissible range, the method comprising steps of:
the sensor performing an application-phase measurement on the spindle multiple times to respectively generate a plurality of detection signals under a condition where the spindle of the machine tool is rotating at a preset speed, and transmitting the detection signals to the processing device;
the processing device utilizing principal components analysis (PCA) to characterize the detection signals to obtain a detection probabilistic model, and determining a detection value based on the detection probabilistic model; and
the processing device determining a distance between the detection value and the normal-condition reference curve, determining, based on the distance between the detection value and the normal-condition reference curve, whether the detection value falls outside of the permissible range, generating a warning signal when it is determined that the detection value falls outside of the permissible range, and transmitting the warning signal to the output device for outputting an alert.

8. The method as claimed in claim 7, before the normal-condition reference curve and the permissible range are stored in the storage medium, the method further comprising steps of:
the sensor performing a preparation-phase measurement on the spindle to respectively generate a plurality of normal-condition signals under a condition where the spindle of the machine tool is idling at the preset speed in a normal condition, and transmitting the normal-condition signals to the processing device;
the processing device establishing a reference model based on the normal-condition signals, and generating a plurality of abnormal-condition signals based on the reference model and a preset damage value;
the processing device utilizing PCA to characterize the normal-condition signals to obtain a normal probabilistic model and characterize the abnormal-condition signals to obtain an abnormal probabilistic model, determining the normal-condition reference curve and an abnormal-condition reference curve respectively based on the normal probabilistic model and the abnormal probabilistic model; and
the processing device determining an alert-triggering line based on the abnormal-condition reference curve, determining the permissible range between the alert-triggering line and the normal-condition reference curve, and transmitting the normal-condition reference curve and the permissible range to the storage medium for storage.

9. The method as claimed in claim 8, wherein the sensor is one of an accelerator, a thermometer and a current detector.

10. The method as claimed in claim 7, wherein each of the normal probabilistic model and the abnormal probabilistic model is a Gaussian mixture model (GMM).

11. The method as claimed in claim 7, wherein the step of determining an alert-triggering line is to determine the alert-triggering line by performing regression analysis on the abnormal-condition reference curve.

12. The method as claimed in claim 7, wherein the step of determining an alert-triggering line is to select a maximum of the abnormal-condition reference curve to define the alert-triggering line.

13. The method as claimed in claim 7, wherein:
in the step of performing a preparation-phase measurement on the spindle multiple times, the preparation-phase measurement is to measure one of vibration of the spindle, temperature of the spindle, and electric current driving the spindle, and each of the normal-condition signals indicates a waveform, in a period of a preset time length, of said one of the vibration of the spindle, the temperature of the spindle, and the electric current driving the spindle.
